(19) United States
(12) Patent Application Publication
(10) Pub. No.: US 2007/0129829 A1
(43) Pub. Date: Jun. 7, 2007

(54) Method for automatically creating an MP3 folder

(76) Inventor: Wayne Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/588,400

(22) Filed: Oct. 27, 2006

(30) Foreign Application Priority Data
Dec. 6, 2005 (TW) 94142953

(51) Int. Cl. G06F 17/00

(52) U.S. Cl. 700/94

(57) ABSTRACT

A method for automatically creating an MP3 folder, includes: firstly, initializing a memory or a memory folder of an electronic product after turning on the electronic production that plays MP3s; next, judging whether an MP3 folder has already been created in the memory of the electronic product; if not, creating an MP3 folder in the memory of the electronic product via an MP3 folder creating program that is stored in the electronic product; and, finally transmitting MP3 files directly from a second electronic product to the MP3 folder. Whereby, the method of the present invention solves the inconvenient problem that users must create an MP3 folder in the memory of the electronic product by themselves.

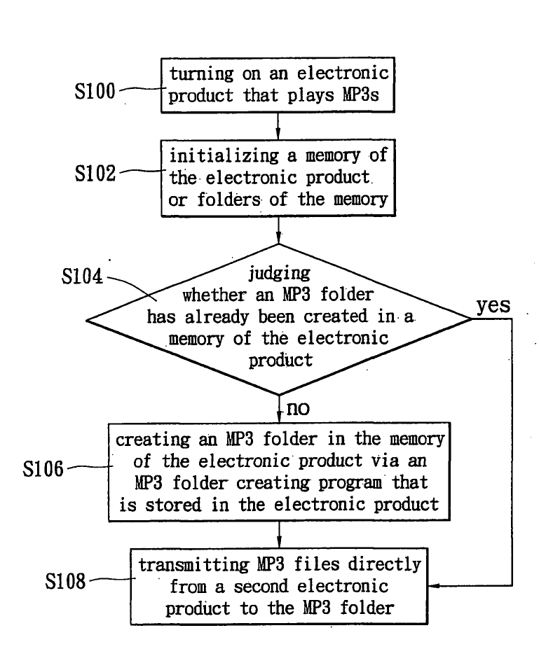

### BACKGROUND OF THE INVENTION

1. Field of the Invention

The present invention relates to a method for automatically creating an MP3 folder, and particularly relates to a method for automatically creating an MP3 folder in the memory of an electronic product via an MP3 folder creating program that is stored in the electronic product.

2. Description of the Related Art

In general, MP3 files need to be stored in an MP3 folder of an MP3 player for an MP3 playing program to read and play the MP3 files easily. Hence, before a product that plays MP3s such as an MP3 player would be exported out, at least one MP3 folder needs to be created in the memory of the product first for judging whether there are any MP3 files in the MP3 folder of the memory via the MP3 playing program.

However, most MP3 players require that the user first create an MP3 folder into which the MP3 files can be stored. Hence, the user needs to read the specifications of the MP3 player first, and then create the MP3 folder step by step according to the specifications. Therefore, it takes up the time of the user and is inconvenient for the user to use the MP3 player. Moreover, if the user does not want to read the specifications, the MP3 playing program does not define the path for the MP3 files and the MP3 files can not be played.

### SUMMARY OF THE INVENTION

The present invention provides a method for automatically creating an MP3 folder. The method of the present invention can automatically create an MP3 folder in the memory of an electronic product via an MP3 folder creating program that is stored in the electronic product. In other words, the user does not need to manually create the MP3 folder in the memory via a computer.

When an electronic product that plays MP3s is turned on, an MP3 folder can be automatically created in the electronic product's built-in or external memory. Therefore, it is easy for the MP3 folder creating program that is stored in the electronic product to judge whether the MP3 folder exists, and it is convenient for the user to use the electronic product, such as an MP3 player.

One aspect of the present invention is a method for automatically creating an MP3 folder, comprising: firstly, initializing a memory or a memory folder of an electronic product after turning on the electronic product that plays MP3s; next, judging whether an MP3 folder has already been created in the memory of the electronic product; if not, creating an MP3 folder in the memory of the electronic product via an MP3 folder creating program that is stored in the electronic product; and, finally transmitting MP3 files directly from a second electronic product to the MP3 folder.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

The FIGURE is a flow chart of a method for automatically creating an MP3 folder according to the present invention.

### DETAILED DESCRIPTION OF PREFERRED BEST MOLDS

Referring to the FIGURE, the present invention provides a method for automatically creating an MP3 folder, including: opening an electronic product that plays MP3s (S100); and initializing a memory of the electronic product or folders of the memory (S102). Moreover, the electronic product can be an MP3 player or a digital camera. In addition, the memory can be a built-in memory or an external memory.

The method of the present invention further comprises: judging whether an MP3 folder has already been created in a memory of the electronic product (S104). If an MP3 folder has not already been created in the memory of the electronic product, creating an MP3 folder in the memory of the electronic product via an MP3 folder creating program that is stored in the electronic product (S106).

Finally, the method comprises transmitting MP3 files directly from a second electronic product to the MP3 folder (S108) for solving the inconvenient problem that users must create an MP3 folder in the memory of the electronic product by themselves. Moreover, the second electronic product is a device for transmitting MP3 files to relevant devices that plays MP3s, and can be a computer or a PDA.

Furthermore, if an MP3 folder has already been created in the memory of the electronic product, the step of S108 is performed.

In conclusion, when an electronic product that plays MP3s is turned on, an MP3 folder can be automatically created in the electronic product's built-in or external memory. Therefore, it is easy for the MP3 folder creating program that is stored in the electronic product to determine whether the MP3 folder exists, and it is convenient for the user to use the electronic product such as an MP3 player.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for automatically creating an MP3 folder, comprising:
after turning on an electronic product that plays MP3s, determining whether an MP3 folder has already been created in a memory of the electronic product;
if the MP3 folder has not already been created in the memory of the electronic product, creating an MP3 folder in the memory of the electronic product via an MP3 folder creating program that is stored in the electronic product; and
transmitting MP3 files directly from a second electronic product to the MP3 folder.

2. The method as claimed in claim 1, further comprising: initializing the memory of the electronic product or folders of the memory, after turning on the electronic production.

3. The method as claimed in claim 1, wherein the electronic product is an MP3 player or a digital camera.

4. The method as claimed in claim 1, wherein the memory is a built-in memory or an external memory.

5. The method as claimed in claim 1, wherein the second electronic product is a computer or a PDA.
